(19) United States
(12) Patent Application Publication
(10) Pub. No.: US 2005/0168573 A1
(43) Pub. Date: Aug. 4, 2005

(54) Plural-mode surveillance system and methodology with differentiated, selectable, twin-output display

(76) Inventors: Michael R. Dennis, Scappoose, OR (US); David M. Dennis, Scappoose, OR (US)

Correspondence Address: ROBERT D. VARITZ, P.C., 2007 S.E. Grant Street, Portland, OR, 97214, US

(21) Appl. No.: 10/634,064

(22) Filed: Jul. 31, 2003

Related U.S. Application Data
(60) Provisional application No. 60/484,264, filed on Jun. 30, 2003.

(51) Int. Cl. H04N 7/18

(52) U.S. Cl. 348/143

(57) ABSTRACT

A multi-information-character, surveillance imaging system and method employing a plural-imager, assembly of surveillance imagers including (a) an optical, daytime, color imager, (b) an optical, nighttime, light-intensified, black-and-white imager, and (c) a thermal imager, and featuring a pair of side-by side adjacent, readily co-viewable, video image display structures. One of these display structures is dedicated to the presentation of thermal imagery, and other is selectively and changeably dedicatable, at any time, to any one alone of the three system imagers. Interconnect structure, including a user-operable controller, operatively and communicatively interconnects the imagers and the display structures in a manner permitting selective user switching of communication between the “other” display structure and one or another of the daytime, nighttime and thermal imagers.

### CROSS-REFERENCE TO RELATED APPLICATION

This application claims priority to U.S. Provisional Patent Application Ser. No. 60/484,264, filed Jun. 30, 2003, for “Surveillance Imaging System and Methodology”.

The entirety of this priority patent application is hereby incorporated herein by reference.

### BACKGROUND AND SUMMARY OF THE INVENTION

This invention pertains to a plural-mode, multi-information-character surveillance imaging system and methodology. In particular, it relates to such a system and methodology which feature the use of a differentiated, selectable, twin-visual-output display arrangement, and which enable special comparative viewing, via this arrangement, of surveillance imagery collected by different ones of several, different-mode imagers. For the purpose of illustration herein, a preferred and best mode embodiment of, and manner of practicing, the invention are described in the setting of an overall surveillance imaging system which employs nighttime, daytime and thermal surveillance imaging structures and modalities. The preferred implementation of the system also features a very simple, one-hand-operable, computer-based controller which offers touch-screen and joystick functionalities that enable very sophisticated, quick and accurate user “manipulation” of system behavior in ways that allow virtually unchallenged operator visual attention to be paid to the twin-output, mode-comparative visual displays proposed by the invention.

In the practice of surveillance imagery utilizing different modes of imagery, such as the three modes mentioned above, it is very useful under many different kinds of circumstances to be able to make a simultaneous, or near simultaneous, visual comparison between imagery data derived from two different modes. For example, during daylight hours, it may be important to have both color optical and thermal imagery available respecting the same scene in order to obtain better information about what may be pictured in that scene that might be of some surveillance concern. Similarly, at nighttime, a like kind of comparison might be desired between light-intensified nighttime imagery and thermal imagery. These are just two of many other relevant illustrations.

Proposed structurally by the present invention is a surveillance imaging system which very easily accommodates these considerations by furnishing, in an operational setting where imagery is available at different times selectively from a thermal imager, from a daytime, color video imager, and from a light-intensified, black-and-white, nighttime imager, a pair of closely spaced side-by-side display devices on whose screens different kinds of comparative imagery derived from these imagers can be presented.

Another illustrative situation wherein side-by-side comparative surveillance imagery may be important involves information that is desirable to obtain under certain kinds of challenging light-of-day conditions which typically exist around daybreak and twilight. Here there are circumstances where it would be very useful to be able to view, in addition to thermal imagery, a comparative cross-relationship between daytime color imagery and nighttime light-intensified imagery. As will be seen, the system and methodology of this invention readily accommodate this challenging circumstance.

The various features and other advantages that are offered by the system and methodology of this invention will become more fully apparent as the description which now follows is read in conjunction with the accompanying drawings.

### DESCRIPTION OF THE DRAWINGS

FIG. 1A is a simplified and stylized isometric view of a multi-imager, plural-mode surveillance system which employs a pair of side-by-side imaging display devices which are constructed, and employed methodologically, in accordance with the present invention. At the right side of this figure, fragmentary dash-double-dot lines illustrate one modified form of the system shown centrally in the figure.

FIG. 1B is a simplified block/schematic illustration of another modified form of the system centrally pictured in FIG. 1A.

FIG. 2 is a view of portions of the system illustrated in FIG. 1A focusing attention on selectable, dual side-by-side display structures which operate in accordance with preferred practice of the present invention.

FIG. 3 pictures a computer-generated display on a user-interface touch screen in a computer-based controller which is employed in the system of FIG. 1A. This figure shows a typical touch-screen appearance for a situation where currently co-active in the system of this invention are a daytime color imager and a thermal imager whose respective outputs are being fed simultaneously to a pair of side-by-side visual display devices provided in accordance with this invention.

FIG. 4 is similar to FIG. 3, except that here what is shown is a typical touch-screen-display provided in the system of FIG. 1A where currently coactive in the imaging system shown in FIG. 1A are a light-intensified, black-and-white, nighttime imager, and a thermal imager.

FIG. 5 is similar to FIGS. 3 and 4, except that here what is shown is a user-interface touch screen presentation active under circumstances where only a thermal imager in the system of FIG. 1A is active.

FIGS. 6 and 7 illustrate same-scene, comparative, thermal and daytime imagery, respectively, of a helicopter in flight.

FIGS. 8 and 9 illustrate same-scene, comparative, nighttime light-intensified and thermal imagery, respectively, of a walking person

FIGS. 10, 11 and 12 illustrate same-scene, comparative, thermal, daytime, and nighttime, light-intensified imagery, respectively, viewing a helicopter in flight during twilight. FIG. 10 shows a dedicated thermal image portrayed on the screen in one visual display device provided according to the invention. FIGS. 11 and 12 picture selectively alternate “daytime” and “nighttime-intensified” images portrayed on the screen in a side-by-side adjacent, second visual display device provided in accordance with the invention.

### DETAILED DESCRIPTION OF THE INVENTION

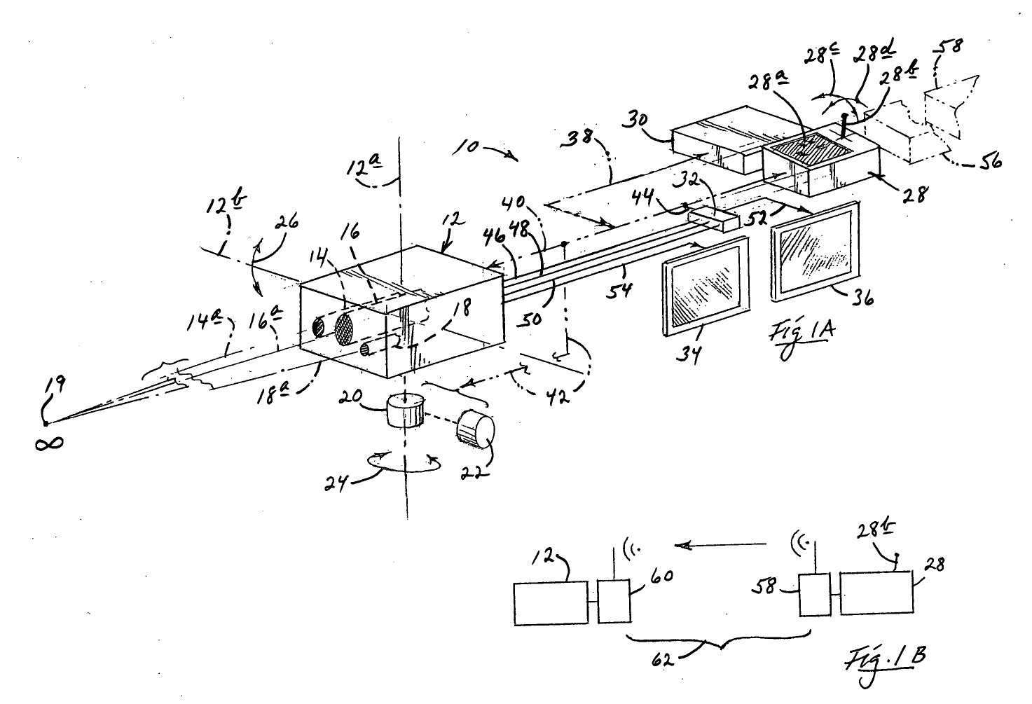

Turning attention now to the drawings, and referring first of all to FIG. 1A, indicated generally at 10 is a surveillance imaging system which includes twin-output display capability in accordance with a preferred and best mode embodiment of, and manner of practicing, the present invention. System 10 is referred to herein as a multi-information-character surveillance imaging system. Included in system 10 are a housing structure, or housing, 12 which is appropriately environmentally sealed, and which contains a plural-imager assembly of surveillance imagers including (a) a nighttime, light-intensified, black-and-white imager 14, (b) a thermal imager 16, and (c) a daytime, color video camera imager 18. While the structure of nighttime imager 14 per se forms no special part of the present invention, it is worth noting that this imager is itself a unique structure which employs the combination of an otherwise conventional light intensifier that feeds intensified night scene imagery to the single CCD optical-to-electronic device contained in an otherwise conventional black-and-white video camera. This camera then produces a rich, black-and-white, intensified nighttime image which is presented, when selected, on a display device (soon to be mentioned) contained in system 10 as an otherwise conventional looking black-and-white image. This black-and-white image lacks the usual harshness and fatiguing characteristics of a conventional, green-spectrum, light-intensified image. The process performed in this imager can be described as gathering and intensifying night scene data to generate a green-spectrum derivative, and converting that derivative to a black-and-white video signal sub-derivative.

Drivingly connected to housing 12, which housing is suitably supported on a stand (not shown), are two computer-controllable electrical motors 20, 22. Motor 20 is selectively operable by an operator/user of system 10 to cause housing 12 (and the contained assembly of imagers) to swing as a unit reversibly back-and-forth angularly (in yaw motion) about a generally upright axis shown at 12a. Such swinging motion is generally indicated in FIG. 1A by double-ended, curved arrow 24 in this figure. Similarly, motor 22 is likewise selectively operable to cause reversible up-and-down angular tilting (a pitch motion) of housing 12, and of the contained imagers, about a generally horizontal axis 12b. This motion is indicated by double-ended, curved arrow 26 in FIG. 1A. Suitably interposed housing 12 and the mentioned (but not illustrated) stand, is conventional motion/articulating structure (also not shown) which enablingly supports housing 12 on the stand for such motions.

Each of imagers 14, 16, 18 is provided with suitable computer-controllable apparatus for effecting selectable changes in various parameters, such as magnification, field of view, focus, and any other appropriate operational parameters. The exact parameters which are associated controllably with each of imagers 14, 16, 18 do not form any part of the present invention.

Further describing generally the assembly of the three imagers, imagers 14, 16, 18 are commonly bore-sighted, or bore-sight aligned, along their respective optical axes 14a, 16a, 18a, at infinity which is represented schematically at 19 on the left side of FIG. 1A. The terminology “commonly bore-sighted” refers to the fact that, effectively at infinity, all three imagers are aimed substantially exactly at the same point in space. This special co-alignment assures, importantly, a substantially commonly shared point of view for all of the imagers. The existence of this shared-point-of-view characteristic, when coupled in system 10 with side-by-side comparative image-viewing capability, as will be explained, greatly enhances the surveillance information-giving capabilities of the system.

Further included in system 10 are (a) a user-operable controller 28 having a touch-sensitive screen 28a, and a multi-axis, manual, mechanical joystick shown at 28b, (b) an appropriate computer 30, (c) video signal switching structure 32, and (d), in accordance with the present invention, a pair of side-by-side video screen display devices 34, 36, also referred to herein as a twin-output display, and as adjacent, co-viewable display structure. Device 34 is also called herein a dedicated display structure, and device 36 a changeably dedicatable device. It is through controller 28 that a user/operator of system 10 exercises selective control over just what comparative surveillance imagery is presented, as will be seen, by devices 34, 36.

Within controller 28, touch screen 28a, through appropriate programming which is managed by computer 30, which computer is appropriately operatively coupled (not specifically shown) to controller 28, enables a user to select and control, among other things, the various operating parameters of imagers 14, 16, 18. Such control includes, for example, switching these imagers into and out of operation, adjusting focus, establishing magnification and thus field of view, and making changes in any other appropriate parameters. Manual joystick 28b is rockable in manners generally indicated by double-ended, curved arrows 28c, 28d to effect housing pitch and yaw angular motions, respectively, of the housing and imager assembly via motors 22, 20, respectively. While a manual joystick is specifically shown in controller 28, it should be understood that joy-stick functionality may, if desired, be provided in a virtual sense by way of an appropriate touchable screen image provided on touch screen 28a under the control of computer 30.

Appropriately associated computer-active control lines 38, 40, 42, 44 extend operatively as shown between housing 12 (and the imagers contained therein), motors 20, 22, controller 28, computer 30, and switching structure 32. It is through these lines that control is exercised, via controller 28 and the operation of computer 30, over the imagers' parameter adjustments, the motor operations, and the operations of switching structure 32 which latter “operations” determine which particular comparative modes of imagery are presented at any given time by devices 34, 36. Three additional lines 46, 48, 40 are shown extending between housing 12 and switching structure 32, and another line 52 is shown interconnecting structure 32 and display device 36. Still another line 54 is shown interconnecting housing 12 and display device 34. Controller 28, computer 30, switching structure 32, and the various interconnecting “lines” which are pictured in FIG. 1A, collectively constitute interconnect structure herein.

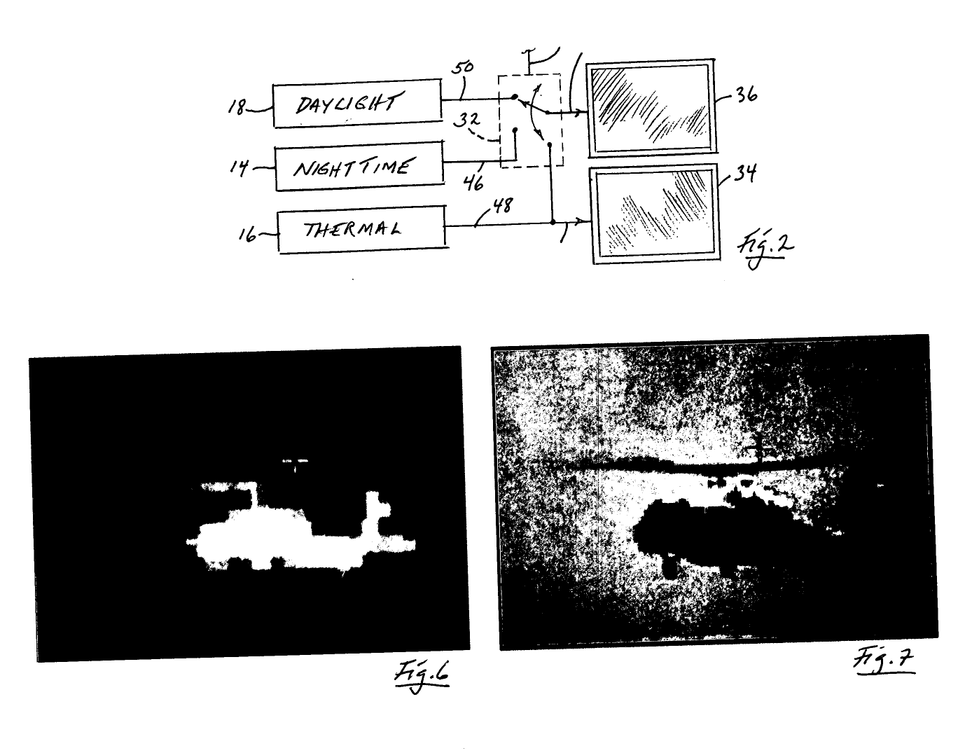

Focusing attention for a moment on FIG. 2, here one sees the fundamental operating relationship which exists between (a) imagers 14, 16, 18, (b) switching structure 32, (c) side-by-side display devices 34, 36, and (d) interconnecting and associated lines 44, 46, 48, 50, 52, 54. Computer-controlled switching operation of structure 32 (via line 44) is here pictured clearly and schematically. The dedicated thermal-imagery condition of display device 34 is plainly evident, as is also the changeable dedicateability of device 36 to the output imagery data stream of any one of the three imagers.

Lines 46, 48, 50 carry video output signals (data streams) from imagers 14, 16, 18, respectively, to switching structure 32. Under the control of touch screen 28a and computer 30, a user/operator can selectively send a signal from any one of these three imagers over line 52 for display of an image on display device 36. Thus display device 36 can selectively and changeably display an image either from nighttime imager 14, from thermal imager 16, or from daytime imager 18. Line 54 dedicatedly delivers video output image information from thermal imager 16 directly to video display device 34.

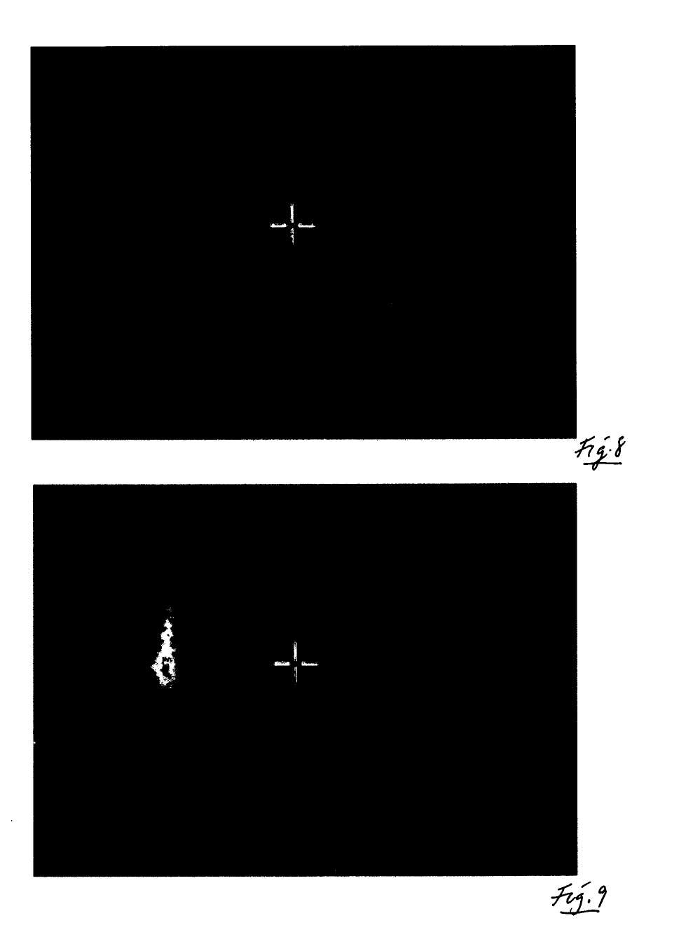

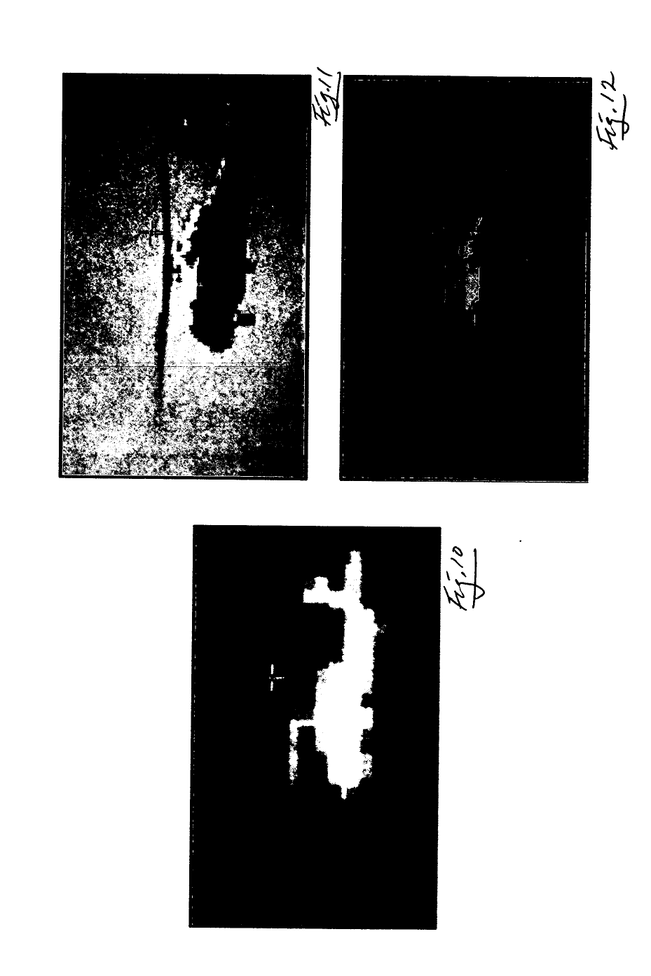

As has been noted above, there are many surveillance applications wherein it is especially useful and important to have available two, side-by-side display devices incorporated into a system, like system 10. Significantly, with this arrangement, as will be seen, daytime and nighttime images presented selectively and changeably on the screen in display device 36 can be cross-related instantly to comparable thermal imagery presented dedicatedly on the screen in display device 34 (See particularly FIGS. 6 and 7 for thermal/daytime comparative imagery, and FIGS. 8 and 9 for nighttime-intensified/thermal comparative imagery). Alternate daytime and light-intensified nighttime views, as during twilight, can be presented for comparison in succession on the screen in device 36 (See particularly FIGS. 11 and 12, respectively), as well as for respective comparisons with same-scene thermal imagery (see FIG. 10).

With focus now returned for a moment to FIG. 1A, shown in dash-double-dot, fragmentary lines 56, 58 at the right side of this figure are portions of two additional controllers which are like controller 28. These additional controllers can be employed, in accordance with one modification of system 10, to offer places for user control that are distributed to different locations. While two such additional controllers are shown at 56, 58, it should be understood that any number of additional controllers, including only a single additional controller, may be employed advantageously if desired.

Still considering systemic modifications that can be made, yet another modification is illustrated generally in FIG. 1B. Here, in very simplified form, a controller 28 is shown operatively connected to a wireless transmitting device 58 which is designed to transmit control information from controller 28 to operable equipment associated with imager housing 12, including all of the imagers provided therein, and the pitch and yaw drive motors. Information transmitted by device 58 is received by an appropriate receiver which is shown at 60 in FIG. 1B, which receiver is suitably operatively connected to all of the controllable apparatus associated with housing 12. The wireless transmission medium employed may be a radio system, a wireless telephone system, the Internet, and so on. A bracket 62 provided in FIG. 1B is presented to emphasize the operative connectedness which exists between blocks 58, 60 in FIG. 1B.

Describing a bit more now about the use, in system 10, of controller 28, touch screen 28a and joystick 28b, in relation to establishing comparative views that may be presented in different ways on the screens in display devices 34, 36, let us turn attention to FIGS. 3-5, inclusive. These three figures illustrate typical virtual control interfaces that may be presented on touch screen 28a to enable a system user, in conjunction with employment of joystick 28b, to implement full internal control over the operating parameters associated with imagers 14, 16 and 18, over the points-of-view (the aim) which may be selected, and over the selection of what modes of imagery to present on the screens in display devices 34, 36. FIG. 3 specifically illustrates a situation wherein the daytime (daylight) and the thermal imagers, 18, 16, respectively, are actively being used in the system. With these two imagers activated, comparative, like-scene imagery, such as that presented in FIGS. 6 (thermal) and 9 (daytime), may be presented on the screens in display devices 34, 36, respectively. Thermal imagery is dedicatedly presented by device 34, and in this illustration daytime, color imagery is selectively presented by display device 36 as a consequence of appropriate user selection of the operating condition for switching structure 32.

FIG. 4 illustrates another typical virtual user interface presentation of virtual controls provided on touch screen 28a under circumstances where the nighttime and thermal imagers, 14, 16, respectively, are active. Under these circumstances, the user/operator of system 10 will have set the condition of switching structure 32 to send nighttime, light-intensified imagery to the screen in device 36. Device 34, of course, presents thermal imagery. FIGS. 8 and 9 illustrate this comparative imagery condition in system 10, with FIG. 8 showing a display on the screen in device 36 of nighttime, light-intensified imagery, and FIG. 9 showing a comparable-scene thermal image on the screen in device 34.

Considering the two touch-screen appearances which are shown in FIGS. 3 and 4, and viewing these along with FIGS. 10, 11 and 12, one can think of these two touch-screen presentations as ones that might exist alternatively under user control on the touch screen under circumstances, say, at twilight when the user/operator of system 10 decides that he or she wishes to look comparatively, along with (or without) thermal imagery (FIG. 10), at alternate, successive, nighttime, light-intensified imagery (FIG. 12) and daytime color imagery (FIG. 11) derived from the two associated imagers. Such nighttime and daytime imagery will be presented solely on the screen in display device 36 through operation, via touch screen 28a, of the operating condition of switching structure 32. As has just been suggested, FIGS. 10 and 11 represent what might appear in time succession alternatively on the screen in device 36 under such circumstances.

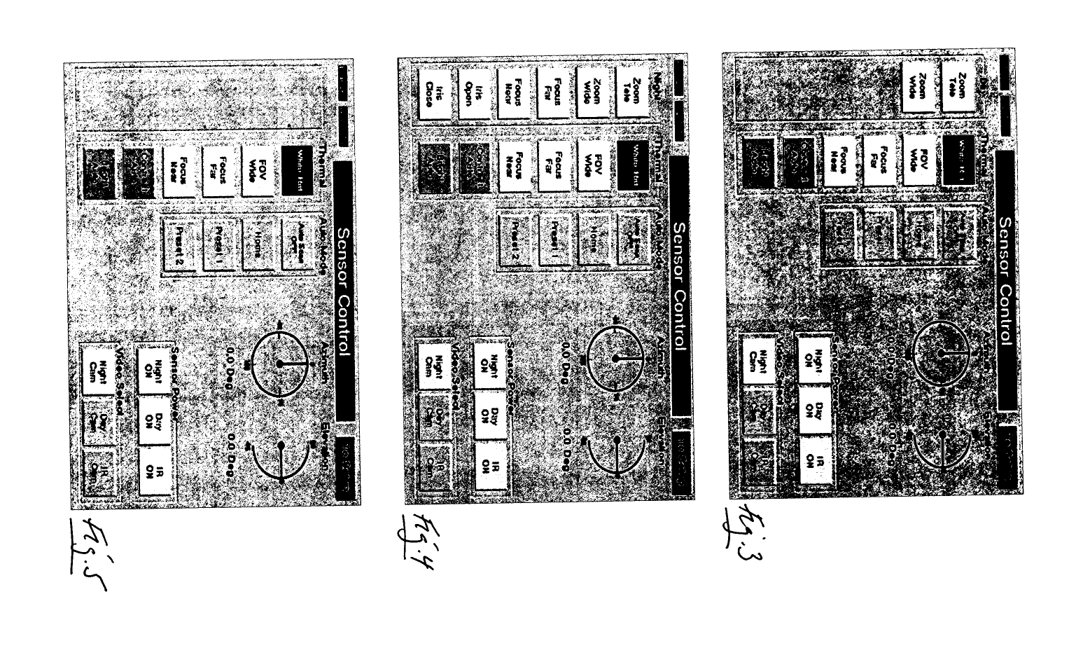

FIG. 5 in the drawings illustrates a typical control touch-screen interface particularly provided for the thermal imager. Such a screen might, for example, be employed as a precursor to preparing for the kind of “three-way”, “two-screen” presentation pictured in FIGS. 10, 11 and 12.

Thus, a novel system and methodology for presenting useful, comparative surveillance imagery, derived from plural, different-mode imagers, are provided by this invention. Side-by-side display devices, fed information quickly, conveniently and selectively variably by the simple and intuitive one-hand-operable control structure furnished in the system, offer a powerful co-viewing tool for gathering and accessing visual surveillance information.

Accordingly, while a preferred embodiment (and certain modifications) of, and manner of practicing, the present invention have been described herein, it is appreciated that variations and modifications may be made without departing from the sprit of the invention.

1. A multi-information-character, surveillance imaging system comprising
a plural-imager, housing-contained assembly of surveillance imagers including (a) an optical, daytime, color video imager, (b) an optical, nighttime, light-intensified, black-and-white video imager, and (c) a thermal imager,
a pair of adjacent, readily co-viewable, video image display structures, one of which is dedicated to the presentation of information derived from said thermal imager, and other of which is selectively and changeably dedicatable to any one of said imagers, and
interconnect structure, including a user-operable controller, operatively and communicatively interconnecting said imagers and said display structures in a manner permitting selective user switching of communication between said other display structure and one or another of said daytime, nighttime and thermal imagers.

2. A multi-information-character, surveillance imaging method comprising
providing a plural-imager, housing-contained assembly of surveillance imagers including (a) an optical, daytime, color video imager, (b) an optical, nighttime, light-intensified, black-and-white video imager, and (c) a thermal imager,
additionally providing a pair of adjacent, readily co-viewable, video image display structures, one of which is dedicated to the presentation of information derived from the thermal imager, and other of which is selectively and changeably dedicatable to any one of said imagers, and
operatively and controllably interconnecting such imagers and said display structures in a manner permitting selective user switching of communication between the other display structure and one or another of the daytime, nighttime and thermal imagers.

3. A plural-mode, plural-display surveillance imaging method comprising
selectively creating data streams representing respective imagery derived by plural, different-mode imagers, including (a) a daytime, color, video imager, (b) a nighttime, black-and-white, light-intensified video imager, and (c) a thermal imager, and
selectively causing the presentations, both in time-simultaneity and in time-succession, on a pair of adjacent, co-viewable display devices, of different selected comparative combinations of associated, different-mode visual images based upon such respective imagery data streams.

4. A surveillance imaging method comprising
selectively acquiring plural-mode, comparable-scene surveillance imagery data, including daytime color imagery data, intensified-light nighttime imagery data, and thermal imagery data, and
enabling, for simultaneous viewing, the selective presentation of dual-mode imagery based upon such data, where such presentation includes visual pairing of (a) daytime and thermal imagery, and (b) nighttime, light-intensified and thermal imagery.

5. The method of claim 4, wherein said acquiring is performed utilizing plural imagers, including (a) a daytime, color video imager, (b) a nighttime, light-intensified video imager, and (c) a thermal imager, all of which imagers include respective imaging axes, all of which axes are bore-sight aligned at infinity.

6. The method of claim 5, wherein the acquiring performance of the nighttime imager includes gathering and intensifying night scene data to generate a green-spectrum derivative, and converting that derivative to a black-and-white video signal sub-derivative.
